(19) United States
(12) Patent Application Publication
(10) Pub. No.: US 2025/0068889 A1
(43) Pub. Date: Feb. 27, 2025

(54) EXPLAINABLE MACHINE LEARNING BASED ON WAVELET ANALYSIS

(71) Applicant: EQUIFAX INC., Atlanta, GA (US)

(72) Inventor: Jeffery Dugger, Atlanta, GA (US)

(21) Appl. No.: 18/719,076

(22) PCT Filed: Dec. 16, 2022
(86) PCT No.: PCT/US2022/081836

§ 371 Date: Jun. 12, 2024

Related U.S. Application Data
(60) Provisional application No. 63/265,687, filed on Dec. 17, 2021.

(51) Int. Cl. G06N 3/0464

(52) U.S. Cl. CPC G06N 3/0464

(57) ABSTRACT

A method can be used to predict risk and provide explainable outcomes using machine learning based on wavelet analysis. A risk prediction model can be applied to time-series data for an attribute associated with a target entity to generate a risk indicator for the target entity. The risk prediction model can include a feature learning model and a risk classification model configured to generate the risk indicator as output. Parameters of the feature learning model can be accessed and a plurality of basis functions of a wavelet transformation can be applied on the parameters of the feature learning model to generate a set of parameter wavelet coefficients. Explanatory data can be generated for the risk indicator based on the set of parameter wavelet coefficients. A responsive message can be transmitted to a remote computing device including the risk indicator and the explanatory data for use in controlling access of the target entity to an interactive computing environment.

### CROSS-REFERENCES TO RELATED APPLICATIONS

This application claims priority to and the benefit of U.S. Provisional Patent Application No. 63/265,687, filed Dec. 17, 2021, entitled “EXPLAINABLE MACHINE LEARNING BASED ON WAVELET ANALYSIS” the entire contents of which is hereby incorporated by reference in its entirety for all purposes.

### TECHNICAL FIELD

The present disclosure relates generally to machine learning and artificial intelligence. More specifically, but not by way of limitation, this disclosure relates to machine learning based on wavelet analysis for assessing risks or performing other operations and for providing explainable outcomes associated with these outputs.

### BACKGROUND

In machine learning, various models (e.g., artificial neural networks) have been used to perform functions such as providing a prediction of an outcome based on input values. These models can provide predictions with high accuracy because of their intricate structures, such as the interconnected nodes in a neural network. However, this also renders these machine learning models black-box models where the output of the model cannot be explained or interpreted. In other words, it is hard to explain why these models generate the specific results from the input values. As a result, it is hard, if not impossible, to justify, track or verify the results and to improve the model based on the results.

### SUMMARY

Various aspects of the present disclosure provide systems and methods for performing machine learning based on wavelet analysis for assessing risks or performing other operations and for providing explainable outcomes associated with the outputs. A risk prediction model can be applied to time-series data for an attribute associated with a target entity to generate a risk indicator for the target entity. The risk prediction model can include a feature learning model configured to receive the time-series data as input and a risk classification model configured to receive output of the feature learning model and generate the risk indicator as output. Parameters of the feature learning model can be accessed and a plurality of basis functions of a wavelet transformation can be applied on the parameters of the feature learning model to generate a set of parameter wavelet coefficients. Explanatory data can be generated for the risk indicator based on the set of parameter wavelet coefficients. A responsive message can be transmitted to a remote computing device including at least the risk indicator and the explanatory data for use in controlling access of the target entity to one or more interactive computing environments.

In other aspects, a system can include a processor and a non-transitory computer-readable medium including instructions that are executable by the processor to cause the processor to perform various operations. The system can apply a risk prediction model to time-series data for an attribute associated with a target entity to generate a risk indicator for the target entity. The risk prediction model can include a feature learning model configured to receive the time-series data as input and a risk classification model configured to receive output of the feature learning model and generate the risk indicator as output. The system can access parameters of the feature learning model and apply a plurality of basis functions of a wavelet transformation on the parameters of the feature learning model to generate a set of parameter wavelet coefficients. The system can generate explanatory data for the risk indicator based on the set of parameter wavelet coefficients. The system can transmit, to a remote computing device, a responsive message including at least the risk indicator and the explanatory data for use in controlling access of the target entity to one or more interactive computing environments.

In other aspects, a non-transitory computer-readable medium can include instructions that are executable by a processing device for causing the processing device to perform various operations. The operations can include applying risk prediction model to time-series data for an attribute associated with a target entity to generate a risk indicator for the target entity. The risk prediction model can include a feature learning model configured to receive the time-series data as input and a risk classification model configured to receive output of the feature learning model and generate the risk indicator as output. The operations can further include accessing parameters of the feature learning model and applying a plurality of basis functions of a wavelet transformation on the parameters of the feature learning model to generate a set of parameter wavelet coefficients. The operations can further include generating explanatory data for the risk indicator based on the set of parameter wavelet coefficients. The operations can further include transmitting, to a remote computing device, a responsive message including at least the risk indicator and the explanatory data for use in controlling access of the target entity to one or more interactive computing environments.

This summary is not intended to identify key or essential features of the claimed subject matter, nor is it intended to be used in isolation to determine the scope of the claimed subject matter. The subject matter should be understood by reference to appropriate portions of the entire specification, any or all drawings, and each claim.

The foregoing, together with other features and examples, will become more apparent upon referring to the following specification, claims, and accompanying drawings.

### BRIEF DESCRIPTION OF THE DRAWINGS

FIG. 1 is a block diagram depicting an example of a computing environment in which explanatory data can be generated for a machine learning model by applying wavelet analysis on the trained model parameters, according to certain aspects of the present disclosure.

FIG. 2 is a flow chart depicting an example of a process for utilizing a machine learning model to generate risk indicators and explanatory data through wavelet analysis for a target entity, according to certain aspects of the present disclosure.

FIG. 3 is a diagram depicting an example of the architecture of a risk prediction model that can be generated for risk prediction, according to certain aspects of the present disclosure.

FIG. 4 is a diagram depicting an example of convolution operation involved in the convolutional layer of the risk prediction model, according to certain aspects of the present disclosure.

FIG. 5 is a diagram depicting a convolution operation implemented through nodes of the risk prediction model, according to certain aspects of the present disclosure.

FIG. 6 is a diagram depicting examples of operations involved in a convolutional layer of the risk prediction model, according to certain aspects of the present disclosure.

FIG. 7 is a diagram depicting examples of learned parameters for a convolution layer and wavelet coefficients generated by applying a wavelet transformation to the learned parameters, according to certain aspects of the present disclosure.

FIGS. 8A-8B show charts depicting examples of basis functions of a wavelet transformation and approximating time-series data with basis functions, according to certain aspects of the present disclosure.

FIG. 8C shows a chart depicting another example of basis functions of a wavelet transform, according to certain aspects of the present disclosure.

FIG. 9 shows graphs depicting examples of wavelet coefficients and corresponding basis functions applied to time-series data, according to certain aspects of the present disclosure.

FIG. 10 is a block diagram depicting an example of a computing system suitable for implementing certain aspects of the present disclosure.

### DETAILED DESCRIPTION

Certain aspects described herein are provided for generating explanatory data for a prediction model based on wavelet analysis on time-series data. A risk assessment computing system, in response to receiving a risk assessment query for a target entity, can access a risk prediction model trained to generate a risk indicator for the target entity based on time-series data for an attribute associated with the target entity. The risk assessment computing system can apply the risk prediction model on time-series data to compute the risk indicator. The risk assessment computing system may also generate explanatory data by applying wavelet analysis on parameters of the risk prediction model to explain the impact of the attribute on the risk indicator. The risk assessment computing system can transmit a response to the risk assessment query for use by a remote computing system in controlling access of the target entity to one or more interactive computing environments. The response can include the risk indicator and the explanatory data.

For example, the risk prediction model can be a convolutional neural network (CNN)-based model including a feature learning model and a risk classification model. The feature learning model can be a convolutional neural network configured to accept time-series data as input and output a feature vector. The time-series data can be values for an attribute associated with the target entity. The time-series data instances of an attribute can contain different values of the attribute at different time points. For example, if the attribute describes the amount of available storage space of a computing device, a time-series data of the attribute can include 32 instances each representing the available storage space at 5:00 pm on each day for 32 consecutive days. The time-series data of the attribute captures the changes of the attribute over time. The risk classification model can be a neural network configured to accept the feature vector as input and output a risk indicator for the target entity.

The training of the risk prediction model can involve adjusting the parameters of the model based on time-series data instances of the attribute and risk indicator labels. The adjustable parameters of the neural network can include the weights of the connections among the nodes in different layers, the number of nodes in a layer of the network, the number of layers in the network, and so on. The parameters can be adjusted to optimize a loss function determined based on the risk indicators generated by the risk prediction model from the time-series data instances of the training attributes and the risk indicator labels.

In some aspects, the trained risk prediction model can be used to predict risk indicators. For example, a risk assessment query for a target entity can be received from a remote computing device. In response to the assessment query, time-series data instances can be generated for an attribute associated with the target entity. An output risk indicator for the target entity can be computed by applying the risk prediction model to the time-series data instances of the attribute.

Further, explanatory data indicating features or characteristics of the time-series data instances of the attribute that have higher contribution to the determined risk indicator can also be calculated or determined. To generate the explanatory data, basis functions of a wavelet transformation can be applied on parameters of the trained feature learning model (e.g., convolutional neural network). Applying the basis functions on the parameters can generate a set of parameter wavelet coefficients. Parameter wavelet coefficients in the set that have higher values than other coefficients can be used to explain the features or characteristics that lead to the predicted risk prediction. A responsive message including at least the output risk indicator and the explanatory data can be transmitted to the remote computing device.

To determine the set of basis functions, parameters of the feature learning model can be accessed. The parameters can be weights, coefficients, or other parameters of the feature learning model. Basis functions of the wavelet transformation can be applied on the parameters of the feature learning model to generate corresponding parameter wavelet coefficients. A subset of parameter wavelet coefficients can be selected from the parameter wavelet coefficients. For example, parameter wavelet coefficients that are higher than remaining parameter wavelet coefficients in the set may be selected. Each parameter wavelet coefficient in the subset of parameter wavelet coefficients corresponds to a basis function and this subset of basis functions can be applied to the time-series data to generate the subset of wavelet coefficients used to generate the explanatory data.

Certain aspects described herein, which can include operations and data structures with respect to the convolutional neural network, can provide accurate explanatory data for a CNN-based prediction model by applying wavelet basis functions on input time-series data, thereby overcoming the issues identified above. For instance, by identifying wavelet basis function from the trained convolutional neural network and applying these basis functions on the time-series data instances, explanatory data can be generated to reflect features learned and used by the model for prediction. Applying the basis functions provides insights to the time-series data and the prediction results, thereby allowing the prediction results to be explained accurately.

These illustrative examples are given to introduce the reader to the general subject matter discussed here and are not intended to limit the scope of the disclosed concepts. The following sections describe various additional features and examples with reference to the drawings in which like numerals indicate like elements, and directional descriptions are used to describe the illustrative examples but, like the illustrative examples, should not be used to limit the present disclosure.

### Operating Environment Example for Machine-Learning Operations

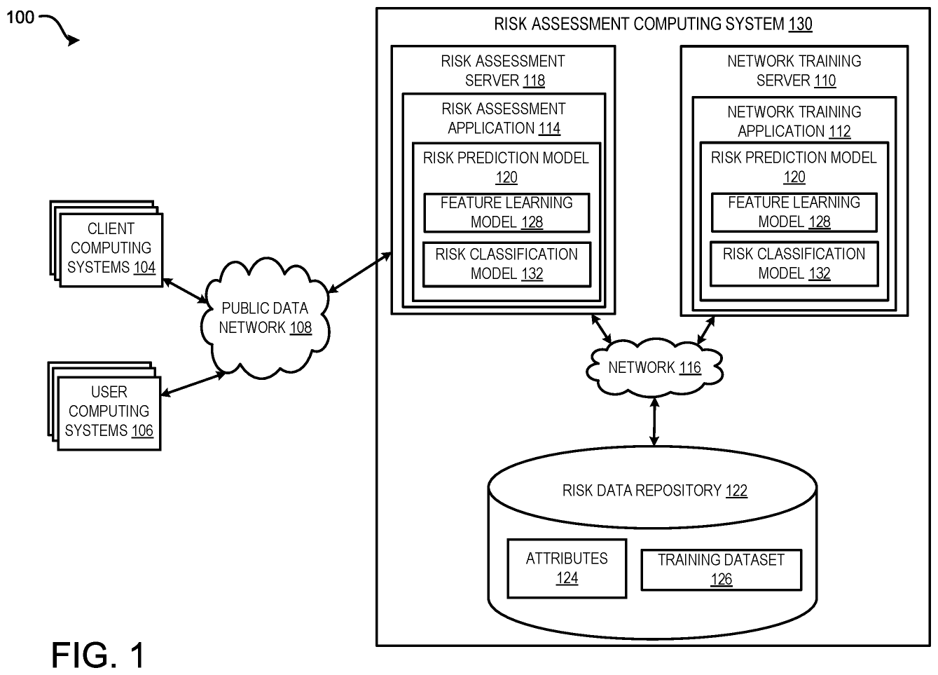

Referring now to the drawings, FIG. 1 is a block diagram depicting an example of an operating environment 100 in which a risk assessment computing system 130 can build and use a risk prediction model to provide risk predictions and use wavelet analysis to generate explanatory data for the generated risk prediction. FIG. 1 depicts examples of hardware components of a risk assessment computing system 130, according to some aspects. The risk assessment computing system 130 can be a specialized computing system that may be used for processing large amounts of data using a large number of computer processing cycles. The risk assessment computing system 130 can include a network training server 110 for building and training a risk prediction model 120 wherein the risk prediction model 120 can be a convolutional neural network model-based model with a feature learning model 128 and a risk classification model 132. The risk assessment computing system 130 can further include a risk assessment server 118 for performing a risk assessment for given time-series data for attributes 124 using the trained risk prediction model 120.

The network training server 110 can include one or more processing devices that execute program code, such as a network training application 112. The program code can be stored on a non-transitory computer-readable medium. The network training application 112 can execute one or more processes to train and optimize a model for predicting risk indicators based on time-series data for attributes 124.

In some aspects, the network training application 112 can build and train a risk prediction model 120 utilizing a training dataset 126. The training dataset 126 can include multiple training vectors consisting of training time-series data for attributes and training risk indicator outputs corresponding to the training vectors. The training dataset 126 can be stored in one or more network-attached storage units on which various repositories, databases, or other structures are stored. Examples of these data structures are the risk data repository 122.

Network-attached storage units may store a variety of different types of data organized in a variety of different ways and from a variety of different sources. For example, the network-attached storage unit may include storage other than primary storage located within the network training server 110 that is directly accessible by processors located therein. In some aspects, the network-attached storage unit may include secondary, tertiary, or auxiliary storage, such as large hard drives, servers, virtual memory, among other types. Storage devices may include portable or non-portable storage devices, optical storage devices, and various other mediums capable of storing and containing data. A machine-readable storage medium or computer-readable storage medium may include a non-transitory medium in which data can be stored and that does not include carrier waves or transitory electronic signals. Examples of a non-transitory medium may include, for example, a magnetic disk or tape, optical storage media such as a compact disk or digital versatile disk, flash memory, memory, or memory devices.

The risk assessment server 118 can include one or more processing devices that execute program code, such as a risk assessment application 114. The program code can be stored on a non-transitory computer-readable medium. The risk assessment application 114 can execute one or more processes to utilize the risk prediction model 120 trained by the network training application 112 to predict risk indicators based on input time-series data for attributes 124. In addition, the risk prediction model 120 can also be utilized to generate explanatory data for the time-series data for attributes 124 by applying basis functions of a wavelet transformation on parameters of the feature learning model 128, which can indicate an effect or an amount of impact that one or more attributes have on the risk indicator.

The output of the trained risk prediction model 120 can be utilized to modify a data structure in the memory or a data storage device. For example, the predicted risk indicator and/or the explanatory data can be utilized to reorganize, flag, or otherwise change the time-series data for attributes 124 involved in the prediction by the risk prediction model 120. For instance, time-series data for attributes 124 stored in the risk data repository 122 can be attached with flags indicating their respective amount of impact on the risk indicator. Different flags can be utilized for different time-series data for attributes 124 to indicate different levels of impact. Additionally, or alternatively, the locations of the time-series data for attributes 124 in the storage, such as the risk data repository 122, can be changed so that the time-series data for attributes 124 or groups of time-series data for attributes 124 are ordered, ascendingly or descendingly, according to their respective amounts of impact on the risk indicator.

By modifying the attributes 124 in this way, a more coherent data structure can be established which enables the data to be searched more easily. In addition, further analysis of the risk prediction model 120 and the outputs of the risk prediction model 120 can be performed more efficiently. For instance, time-series data for attributes 124 having the most impact on the risk indicator can be retrieved and identified more quickly based on the flags and/or their locations in the risk data repository 122. Further, updating the risk prediction model 120, such as re-training the risk prediction model 120 based on new values of the time-series data for attributes 124, can be performed more efficiently especially when computing resources are limited. For example, updating or retraining the risk prediction model 120 can be performed by incorporating new values of the time-series data for attributes 124 having the most impact on the output risk indicator based on the attached flags without utilizing new values of all the time-series data for attributes 124.

Furthermore, the risk assessment computing system 130 can communicate with various other computing systems, such as client computing systems 104. For example, client computing systems 104 may send risk assessment queries to the risk assessment server 118 for risk assessment, or may send signals to the risk assessment server 118 that control or otherwise influence different aspects of the risk assessment computing system 130. The client computing systems 104 may also interact with user computing systems 106 via one or more public data networks 108 to facilitate interactions between users of the user computing systems 106 and interactive computing environments provided by the client computing systems 104.

Each client computing system 104 may include one or more third-party devices, such as individual servers or groups of servers operating in a distributed manner. A client computing system 104 can include any computing device or group of computing devices operated by a seller, lender, or other providers of products or services. The client computing system 104 can include one or more server devices. The one or more server devices can include or can otherwise access one or more non-transitory computer-readable media. The client computing system 104 can also execute instructions that provide an interactive computing environment accessible to user computing systems 106. Examples of the interactive computing environment include a mobile application specific to a particular client computing system 104, a web-based application accessible via a mobile device, etc. The executable instructions are stored in one or more non-transitory computer-readable media.

The client computing system 104 can further include one or more processing devices that are capable of providing the interactive computing environment to perform operations described herein. The interactive computing environment can include executable instructions stored in one or more non-transitory computer-readable media. The instructions providing the interactive computing environment can configure one or more processing devices to perform operations described herein. In some aspects, the executable instructions for the interactive computing environment can include instructions that provide one or more graphical interfaces. The graphical interfaces are used by a user computing system 106 to access various functions of the interactive computing environment. For instance, the interactive computing environment may transmit data to and receive data from a user computing system 106 to shift between different states of the interactive computing environment, where the different states allow one or more electronics transactions between the user computing system 106 and the client computing system 104 to be performed.

In some examples, a client computing system 104 may have other computing resources associated therewith (not shown in FIG. 1), such as server computers hosting and managing virtual machine instances for providing cloud computing services, server computers hosting and managing online storage resources for users, server computers for providing database services, and others. The interaction between the user computing system 106 and the client computing system 104 may be performed through graphical user interfaces presented by the client computing system 104 to the user computing system 106, or through application programming interface (API) calls or web service calls.

A user computing system 106 can include any computing device or other communication device operated by a user, such as a consumer or a customer. The user computing system 106 can include one or more computing devices, such as laptops, smartphones, and other personal computing devices. A user computing system 106 can include executable instructions stored in one or more non-transitory computer-readable media. The user computing system 106 can also include one or more processing devices that are capable of executing program code to perform operations described herein. In various examples, the user computing system 106 can allow a user to access certain online services from a client computing system 104 or other computing resources, to engage in mobile commerce with a client computing system 104, to obtain controlled access to electronic content hosted by the client computing system 104, etc.

For instance, the user can use the user computing system 106 to engage in an electronic transaction with a client computing system 104 via an interactive computing environment. An electronic transaction between the user computing system 106 and the client computing system 104 can include, for example, the user computing system 106 being used to request online storage resources managed by the client computing system 104, acquire cloud computing resources (e.g., virtual machine instances), and so on. An electronic transaction between the user computing system 106 and the client computing system 104 can also include, for example, query a set of sensitive or other controlled data, access online financial services provided via the interactive computing environment, submit an online credit card application or other digital application to the client computing system 104 via the interactive computing environment, operating an electronic tool within an interactive computing environment hosted by the client computing system (e.g., a content-modification feature, an application-processing feature, etc.).

In some aspects, an interactive computing environment implemented through a client computing system 104 can be used to provide access to various online functions. As a simplified example, a website or other interactive computing environment provided by an online resource provider can include electronic functions for requesting computing resources, online storage resources, network resources, database resources, or other types of resources. In another example, a website or other interactive computing environment provided by a financial institution can include electronic functions for obtaining one or more financial services, such as loan application and management tools, credit card application and transaction management workflows, electronic fund transfers, etc. A user computing system 106 can be used to request access to the interactive computing environment provided by the client computing system 104, which can selectively grant or deny access to various electronic functions. Based on the request, the client computing system 104 can collect data associated with the user and communicate with the risk assessment server 118 for risk assessment. Based on the risk indicator predicted by the risk assessment server 118, the client computing system 104 can determine whether to grant the access request of the user computing system 106 to certain features of the interactive computing environment.

In a simplified example, the system depicted in FIG. I can configure a risk prediction to be used both for accurately determining risk indicators, such as credit scores, using time-series data for attributes and determining explanatory data for the attributes. An attribute can be any variable predictive of risk that is associated with an entity. Any suitable attribute that is authorized for use by an appropriate legal or regulatory framework may be used.

Examples of time-series data for attributes used for predicting the risk associated with an entity accessing online resources include, but are not limited to, variables indicating the demographic characteristics of the entity over a predefined period of time (e.g., the revenue of the company over the past twenty-four consecutive months), variables indicative of prior actions or transactions involving the entity over a predefined period of time (e.g., past requests of online resources submitted by the entity over the past twenty-four consecutive months, the amount of online resource currently held by the entity over the past twenty-four consecutive months, and so on.), variables indicative of one or more behavioral traits of an entity over a predefined period of time (e.g., the timeliness of the entity releasing the online resources over the past twenty-four consecutive months), etc. Similarly, examples of time-series data of attributes used for predicting the risk associated with an entity accessing services provided by a financial institute include, but are not limited to, indicative of one or more demographic characteristics of an entity over a predefined period of time (e.g., income, etc.), variables indicative of prior actions or transactions involving the entity over a predefined period of time (e.g., information that can be obtained from credit files or records, financial records, consumer records, or other data about the activities or characteristics of the entity), variables indicative of one or more behavioral traits of an entity over the past twenty-four consecutive months, etc. For example, time-series data for an account balance attribute can include the account balance for the past thirty-two consecutive months.

The predicted risk indicator can be utilized by the service provider to determine the risk associated with the entity accessing a service provided by the service provider, thereby granting or denying access by the entity to an interactive computing environment implementing the service. For example, if the service provider determines that the predicted risk indicator is lower than a threshold risk indicator value, then the client computing system 104 associated with the service provider can generate or otherwise provide access permission to the user computing system 106 that requested the access. The access permission can include, for example, cryptographic keys used to generate valid access credentials or decryption keys used to decrypt access credentials. The client computing system 104 associated with the service provider can also allocate resources to the user and provide a dedicated web address for the allocated resources to the user computing system 106, for example, by adding it in the access permission. With the obtained access credentials and/or the dedicated web address, the user computing system 106 can establish a secure network connection to the computing environment hosted by the client computing system 104 and access the resources via invoking API calls, web service calls, HTTP requests, or other proper mechanisms.

Each communication within the operating environment 100 may occur over one or more data networks, such as a public data network 108, a network 116 such as a private data network, or some combination thereof. A data network may include one or more of a variety of different types of networks, including a wireless network, a wired network, or a combination of a wired and wireless network. Examples of suitable networks include the Internet, a personal area network, a local area network (“LAN”), a wide area network (“WAN”), or a wireless local area network (“WLAN”). A wireless network may include a wireless interface or a combination of wireless interfaces. A wired network may include a wired interface. The wired or wireless networks may be implemented using routers, access points, bridges, gateways, or the like, to connect devices in the data network.

The number of devices depicted in FIG. 1 is provided for illustrative purposes. Different numbers of devices may be used. For example, while certain devices or systems are shown as single devices in FIG. 1, multiple devices may instead be used to implement these devices or systems. Similarly, devices or systems that are shown as separate, such as the network training server 110 and the risk assessment server 118, may be instead implemented in a signal device or system.

### Examples of Operations Involving Machine-Learning

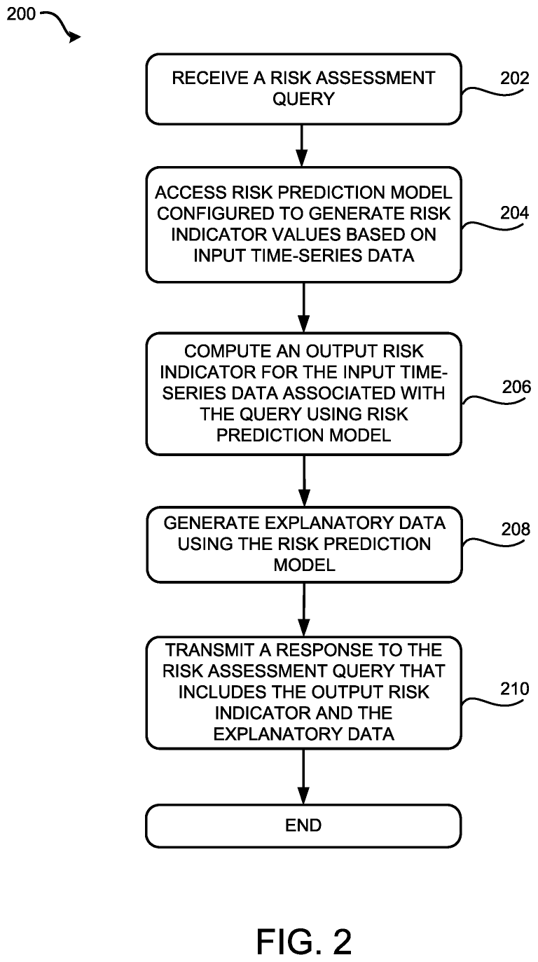

FIG. 2 is a flow chart depicting an example of a process for utilizing a machine learning model to generate risk indicators and explanatory data through wavelet analysis for a target entity, according to certain aspects of the present disclosure. One or more computing devices (e.g., the network training server 110 and the risk assessment server 118) implement operations depicted in FIG. 2 by executing suitable program code (e.g., the network training application 112 and the risk assessment application 114). For illustrative purposes, the process 200 is described with reference to certain examples depicted in the figures. Other implementations, however, are possible.

At block 202, the process 200 involves receiving a risk assessment query for a target entity from a remote computing device, such as a computing device associated with the target entity requesting the risk assessment. The risk assessment query can also be received by the risk assessment server 118 from a remote computing device associated with an entity authorized to request risk assessment of the target entity.

At operation 204, the process 200 involves accessing a risk prediction model trained to generate risk indicator values based on input time-series data or other data suitable for assessing risks associated with an entity. As described in more detail with respect to FIG. 1 above, examples of attributes for time-series data can include data associated with an entity that describes prior actions or transactions involving the entity (e.g., information that can be obtained from credit files or records, financial records, consumer records, or other data about the activities or characteristics of the entity), behavioral traits of the entity, demographic traits of the entity, or any other traits that may be used to predict risks associated with the entity. In some aspects, attributes can be obtained from credit files, financial records, consumer records, etc. The time-series data for the attributes can be values for the attributes of a predefined period of time. For example, the time-series data can be financial records over a twelve-month period, behavioral traits over a twelve-month period, etc. The risk indicator can indicate a level of risk associated with the entity, such as a credit score of the entity.

The risk prediction model can be constructed and trained based on training samples including training attributes and training risk indicator outputs (also referred to as “risk indicator labels”). The risk prediction model can include a feature learning model that receives time-series data and a risk classification model that receives an output of the feature learning model and generates the risk indicator.

At operation 206, the process 200 involves computing a risk indicator for the input time-series data associated with the risk assessment query using the risk prediction model. Time-series data of an attribute associated with the target entity can be used as input to the risk prediction model. The attribute associated with the target entity can be obtained from an attribute database configured to store attributes associated with various entities. The output of the risk prediction model can include the risk indicator for the target entity based on its current attribute.

At operation 208, the process 200 involves generating explanatory data using the risk prediction model. The explanatory data can indicate features or characteristics for the time-series data instances of the attribute that have a higher contribution to the determined risk indicator. The explanatory data may indicate an impact a time-series data instance has or a group of time-series data instances have on the value of the risk indicator, such as credit score (e.g., the relative impact of the attribute(s) on a risk indicator). To generate the explanatory data, a set of basis functions of a wavelet transformation can be applied on the parameters of the trained feature learning model (e.g., convolutional neural network) to generate a set of wavelet coefficients. Wavelet coefficients in the set that have higher values than other coefficients can be used to explain the features or characteristics that lead to the predicted risk prediction. To determine the set of basis functions, parameters of the feature learning model can be accessed. The parameters can be weights, coefficients, or other parameters of the feature learning model. Basis functions of the wavelet transformation can be applied on the parameters of the feature learning model to generate corresponding parameter wavelet coefficients. A subset of parameter wavelet coefficients can be selected from the set of parameter wavelet coefficients. For example, parameter wavelet coefficients that are higher than remaining parameter wavelet coefficients in the set may be selected. Each parameter wavelet coefficient in the subset of parameter wavelet coefficients corresponds to a basis function and this subset of basis functions can be applied to the time-series data to generate the subset of wavelet coefficients used to generate the explanatory data.

The explanatory data can then be generated based on the subset of wavelet coefficients. For example, the subset of wavelet coefficients including a particular wavelet coefficient can correspond to particular explanatory data for the attribute. In some aspects, the risk assessment application uses the risk prediction model to provide explanatory data that are compliant with regulations, business policies, or other criteria used to generate risk evaluations. Examples of regulations to which the PGCN conforms and other legal requirements include the Equal Credit Opportunity Act (“ECOA”), Regulation B, and reporting requirements associated with ECOA, the Fair Credit Reporting Act (“FCRA”), the Dodd-Frank Act, and the Office of the Comptroller of the Currency (“OCC”).

In some implementations, the explanatory data can be generated for a subset of the attributes that have the highest impact on the risk indicator. For example, the risk assessment application 114 can determine the rank of each attribute based on the impact of the attribute on the risk indicator. A subset of the attributes including a certain number of highest-ranked attributes can be selected and explanatory data can be generated for the selected attributes.

At operation 210, the process 200 involves transmitting a response to the risk assessment query. The response can include the risk indicator generated using the risk prediction model and the explanatory data. The risk indicator can be used for one or more operations that involve performing an operation with respect to the target entity based on a predicted risk associated with the target entity. In one example, the risk indicator can be utilized to control access to one or more interactive computing environments by the target entity. As discussed above with regard to FIG. 1, the risk assessment computing system 130 can communicate with client computing systems 104, which may send risk assessment queries to the risk assessment server 118 to request risk assessment. The client computing systems 104 may be associated with technological providers, such as cloud computing providers, online storage providers, or financial institutions such as banks, credit unions, credit-card companies, insurance companies, or other types of organizations. The client computing systems 104 may be implemented to provide interactive computing environments for customers to access various services offered by these service providers. Customers can utilize user computing systems 106 to access the interactive computing environments thereby accessing the services provided by these providers.

For example, a customer can submit a request to access the interactive computing environment using a user computing system 106. Based on the request, the client computing system 104 can generate and submit a risk assessment query for the customer to the risk assessment server 118. The risk assessment query can include, for example, an identity of the customer and other information associated with the customer that can be utilized to generate attributes. The risk assessment server 118 can perform a risk assessment based on attributes generated for the customer and return the predicted risk indicator and explanatory data to the client computing system 104.

Based on the received risk indicator, the client computing system 104 can determine whether to grant the customer access to the interactive computing environment. If the client computing system 104 determines that the level of risk associated with the customer accessing the interactive computing environment and the associated technical or financial service is too high, the client computing system 104 can deny access by the customer to the interactive computing environment. Conversely, if the client computing system 104 determines that the level of risk associated with the customer is acceptable, the client computing system 104 can grant access to the interactive computing environment by the customer and the customer would be able to utilize the various services provided by the service providers. For example, with the granted access, the customer can utilize the user computing system 106 to access clouding computing resources, online storage resources, web pages or other user interfaces provided by the client computing system 104 to execute applications, store data, query data, submit an online digital application, operate electronic tools, or perform various other operations within the interactive computing environment hosted by the client computing system 104.

The risk assessment application 114 may provide recommendations to a target entity based on the generated explanatory data. The recommendations may indicate one or more actions that the target entity can take to improve the risk indicator (e.g., improve a credit score).

### Examples of Model Architecture and Characteristics

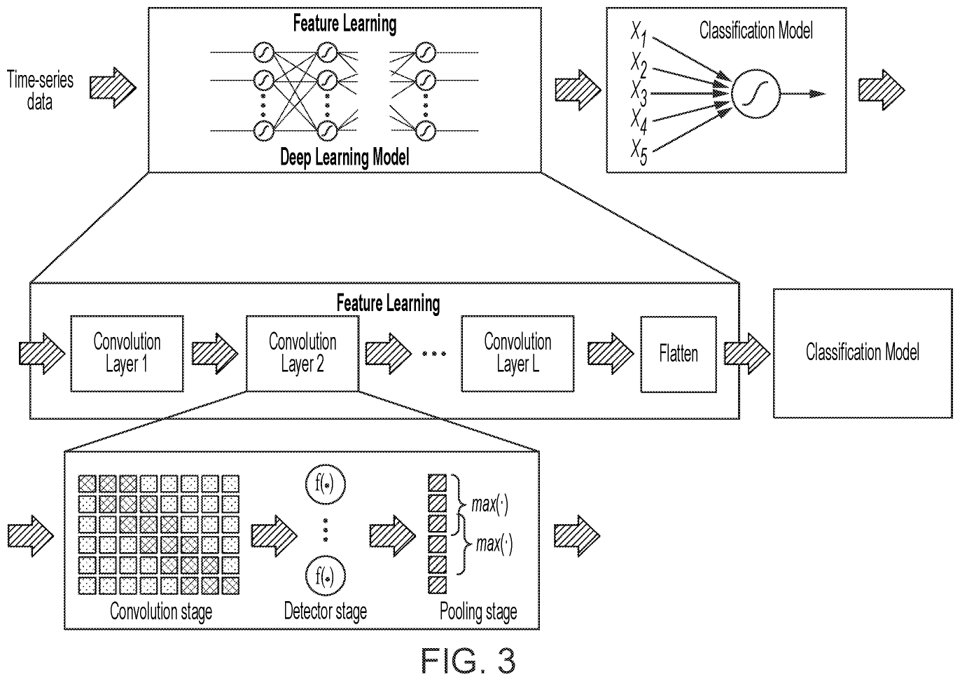

FIG. 3 is a diagram depicting an example of the architecture of a risk prediction model (e.g., risk prediction model 120 in FIG. 1) that can be generated for risk prediction, according to certain aspects of the present disclosure. Time-series data for an entity measured on any desired time scale (e.g., daily, monthly, etc.) for any desired length (e.g., six months, one year, two years, etc.) can be provided as input to a feature learning model. The feature learning model can be a convolutional neural network (CNN) that extracts features from time-series data for improved classification of patterns in the time-series data. For example, the time-series data can correspond to a consumer's credit behavior over time, so the feature learning model can extract features that provide improved classification of patterns in credit behavior data.

The feature learning model includes several convolutional layers followed by a flattening operation to provide a feature vector to a risk classification model. Each convolutional layer can extract more abstract features from the preceding layer. Each convolutional layer includes three stages-a convolution stage, a detector stage, and an optional pooling stage. During training, parameters, such as weights, of the feature learning model are tuned. The detector stage corresponds to the activation function, and may involve a sigmoid function, a rectified linear unit, or another suitable function. For the pooling stage, maximum pooling, average pooling, global pooling, or a different pooling function may be used.

The classification model can be a neural network, a constrained neural network, or a logistic regression model. The classification model receives the feature vector from the feature learning model and generates a risk indicator. As discussed with respect to FIG. 1, the risk indicator can indicate a level of risk associated with the entity, such as a credit score of the entity.

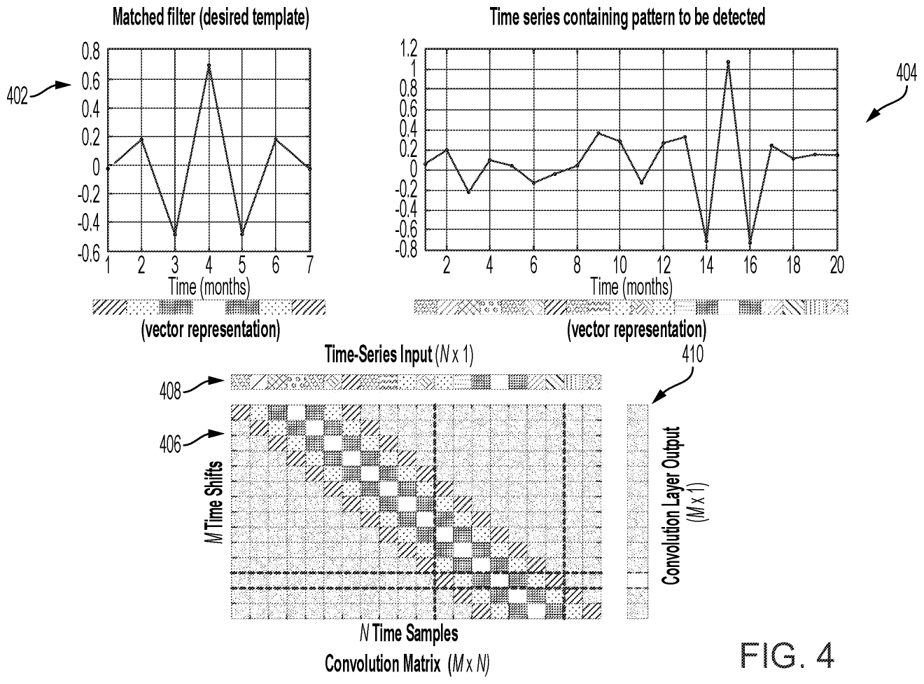

FIG. 4 is a diagram depicting an example of convolution operation involved in the convolutional layer of the risk prediction model, according to certain aspects of the present disclosure. Graph 402 shows a pattern of parameters that the feature learning model has learned through the training of the model. A vector representation of the pattern is also shown below the graph. The convolution operation looks for the pattern in an input time series, shown in graph 404, and determines whether the pattern occurs, to what degree the pattern occurs, and where the pattern occurs in time. A vector representation for the time series is also shown below graph 404. Convolution can be viewed as a time-reversed cross-correlation function. The pattern is “slid” across the time series one sample at a time. At each time-shift, each point in the matched filter, corresponding to the pattern of parameters, is multiplied by the corresponding point in the time series and the results are summed. The pattern is shifted multiple times until it covers the time-series data, resulting in a single number for each shift. This is equivalent to treating the pattern and shifted sections (the same length as the filter) of the time series as vectors and taking the inner product.

Matrix 406 demonstrates the convolution operation as a vector-matrix multiplication, where the N×1 vector 408 corresponds to the input time series data with N samples, and the M×N matrix 406 consists of a set of M shifted versions of the pattern. Each row in the matrix corresponds to a single shift in the convolution operation. A result of this product (shown as an M×1 vector 410) is presented to the detector stage (the activation functions), resulting in an output vector having the same length as the number of shifts.

In a CNN, there may be only a single time step for each shift or multiple time steps for each shift. The size of the step is known as the stride of the convolutional layer. The effect of a stride greater than one is to downsample the incoming data to a lower time resolution.

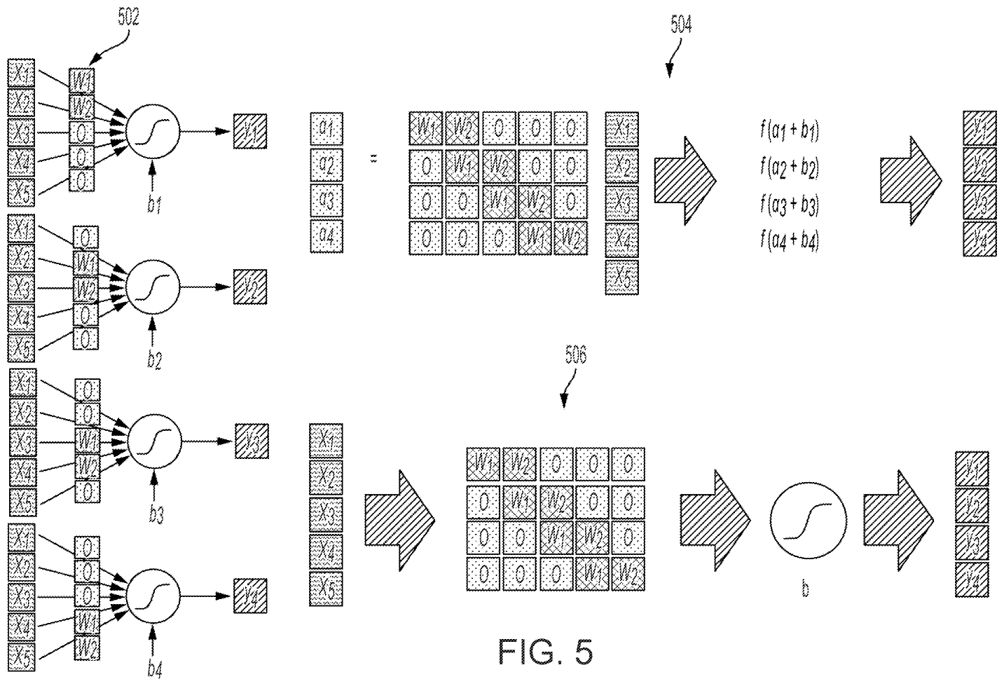

FIG. 5 is a diagram depicting a convolution operation implemented through nodes of the risk prediction model, according to certain aspects of the present disclosure. Each of the nodes operates on the same time-series data inputs with weight sets similar to weight set 502. In a convolutional layer, each node can share the same set of weights shifted into different positions. There can be as many nodes as there are shifts. Operation 504 shows the convolution operation as a matrix-vector multiplication, where each row represents a node. This matrix-vector multiplication represents the convolution operation described in matrix 406 in FIG. 4. The elements of this vector are each passed through their own activation function after being added to a corresponding bias value. Operation 506 shows a further simplified version of this convolution operation, with the activation function graphically illustrated and bias values represented by a vector, b.

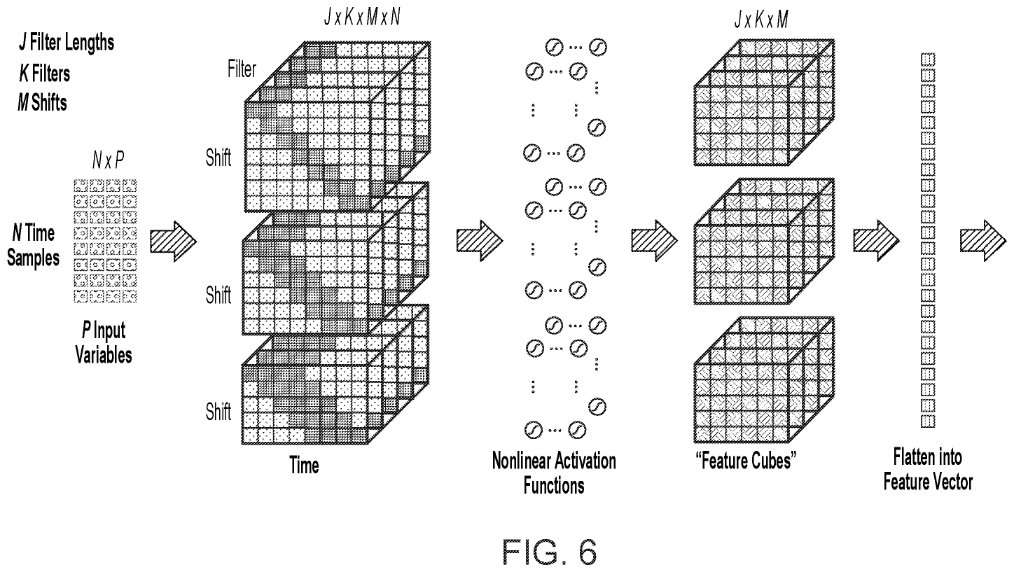

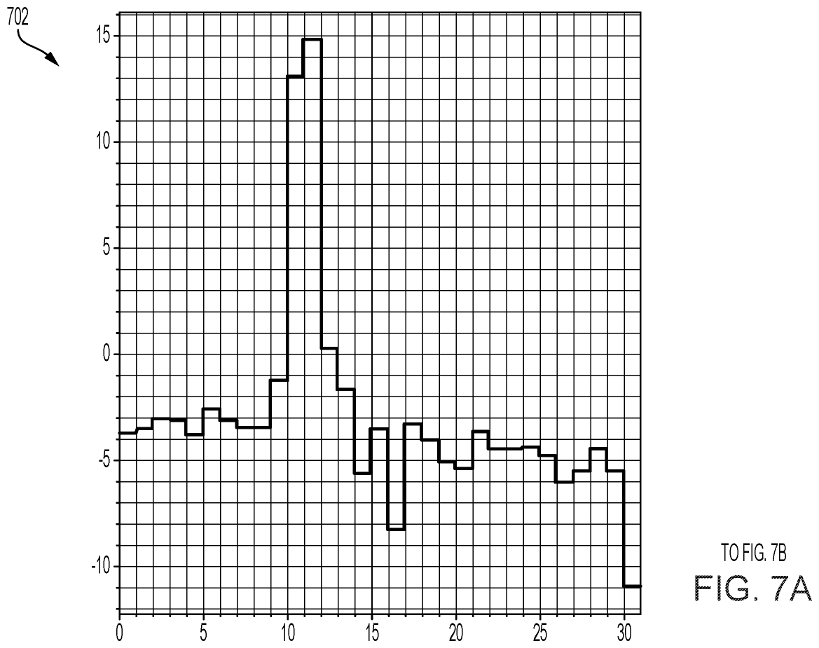

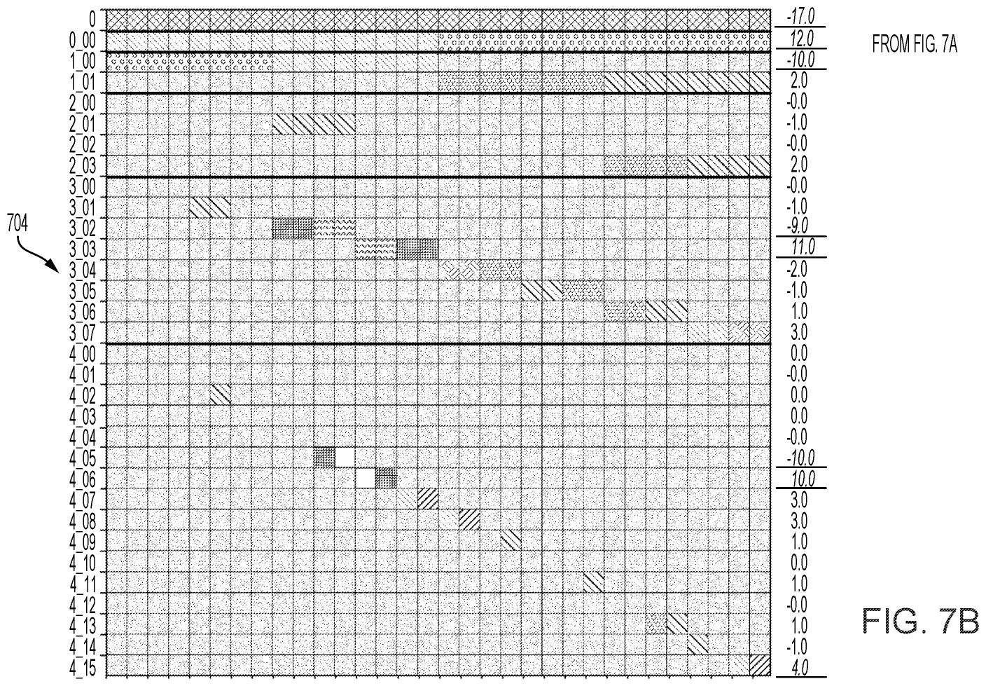

FIG. 6 is a diagram depicting examples of operations involved in a convolutional layer of the risk prediction model according to certain aspects of the present disclosure. In this example, there are sixteen patterns of parameters for each pattern length of two, four, eight, sixteen, and thirty-two months. The patterns of parameters are referred to as filters in FIG. 6. The number of shifts for each pattern length are thirty-one, twenty-nine, twenty-five, seventeen, and one respectively. Each “cube” in FIG. 6 corresponds to a given pattern length, each matrix in each cube corresponds to a given pattern, and each row in each matrix corresponds to a given shift. The cubes are mathematically known as “tensors”, which are a generalization of the concept of vectors and matrices, since tensors are essentially multidimensional arrays. The cubes are rank three tensors, the matrices are rank two tensors, and the matrix rows are rank one tensors. A length of the time series can be thirty-two months since thirty-two is the smallest power of two greater than twenty-four months, but any length may be used. The time-series data can be for any number of attributes. For example, FIG. 7 illustrates time-series data for four attributes. The attributes can correspond to a total balance on all accounts, a number of open accounts, a total high credit, and a total past due amount. The time-series data can be standardized prior to being input to the feature learning model such that they each are made to have zero mean and a standard deviation of one over the time window of thirty-two months.

Each matrix in each cube corresponds to a unique feature learned by the feature learning model, where the parameters represented by the grid-patterned boxes are network weights. The weights are shared over all of the rows in the particular feature matrix, but are shifted by one or more time steps to the right as shown in FIG. 4. A wavelet transformation can be applied to each of these unique patterns of weights, which correspond to the features learned by the feature learning model.

### Examples of Operations Involving Wavelet Analysis

FIG. 7 is a diagram depicting examples of learned parameters for a convolutional layer and wavelet coefficients generated by applying a wavelet transformation to the learned parameters, according to certain aspects of the present disclosure. Graph 702 illustrates the learned parameters for an attribute, such as past due amount, for a pattern of window length thirty-two on a convolutional layer of the feature learning model. The parameters can be a temporal pattern where the parameter at index zero corresponds to a time-instant thirty-two months prior to a performance window and the parameter at index thirty-one corresponds to a time-instant one month prior to the performance window. The learned parameters correspond to the weights in the example shown in FIG. 5. The graph 702 includes a spike in the attribute value from twenty-three to nineteen months prior to the performance window. There is also a downward spike in the attribute value one month prior to the performance window and a slight downward trend in the attribute value over the entire thirty-two months.

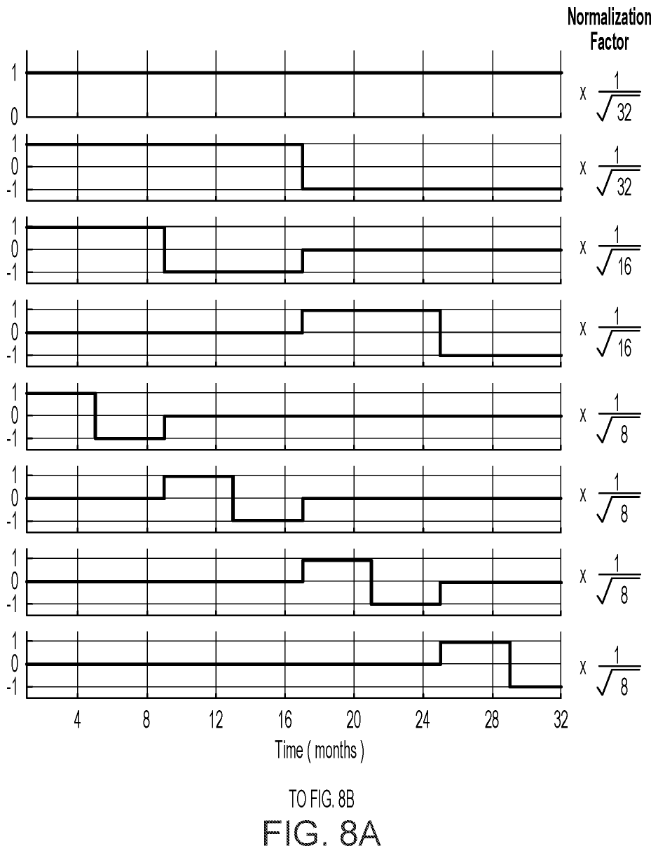

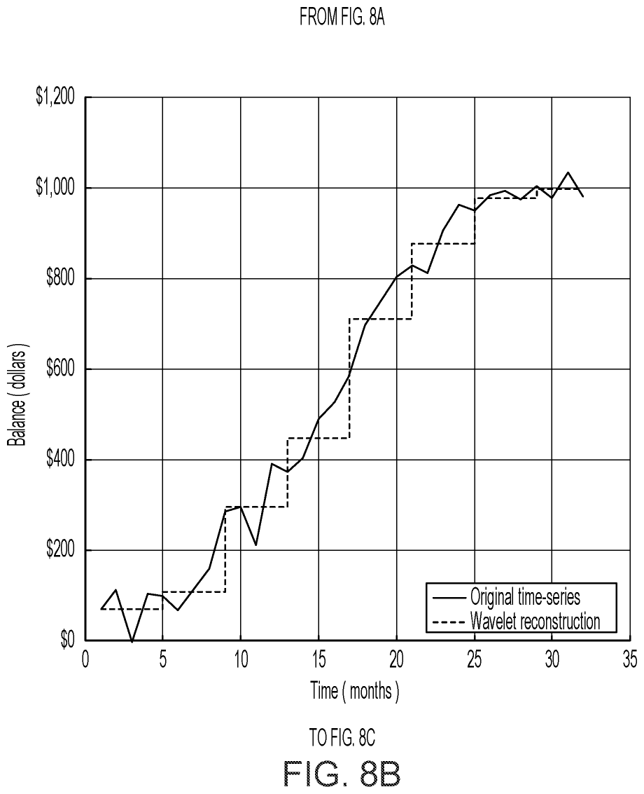

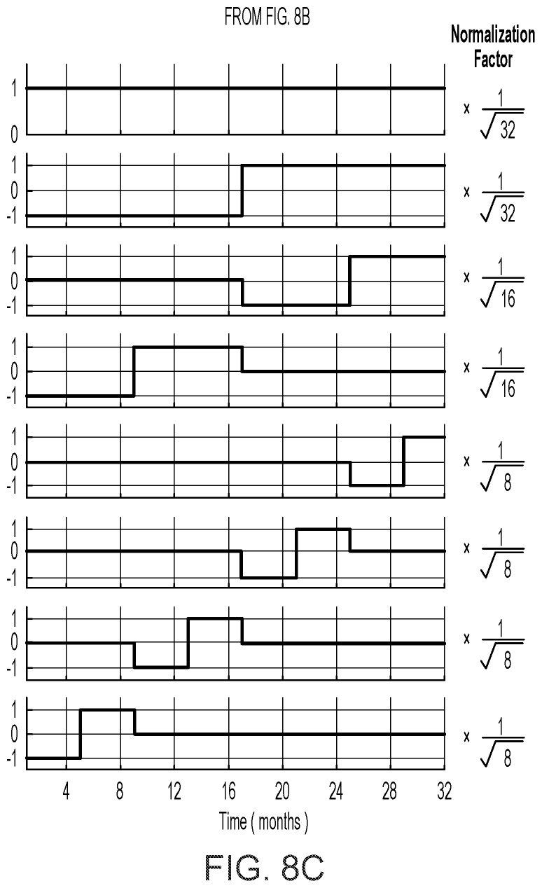

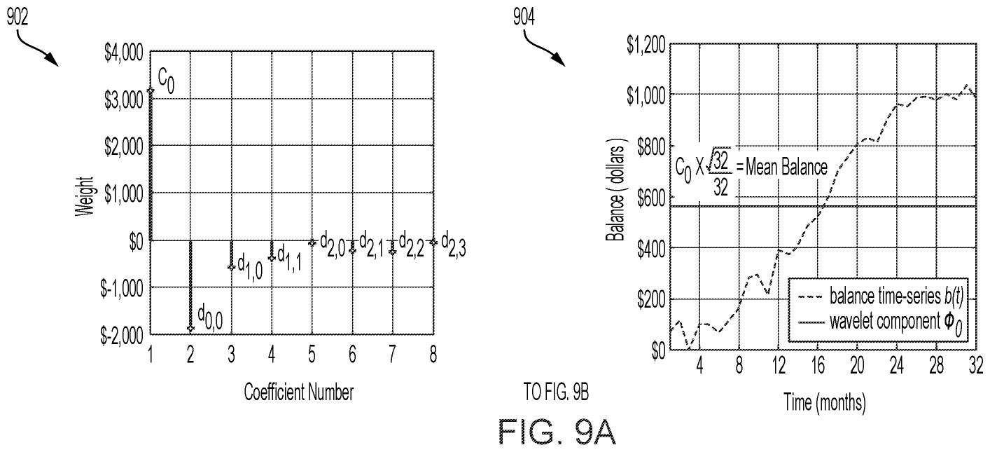

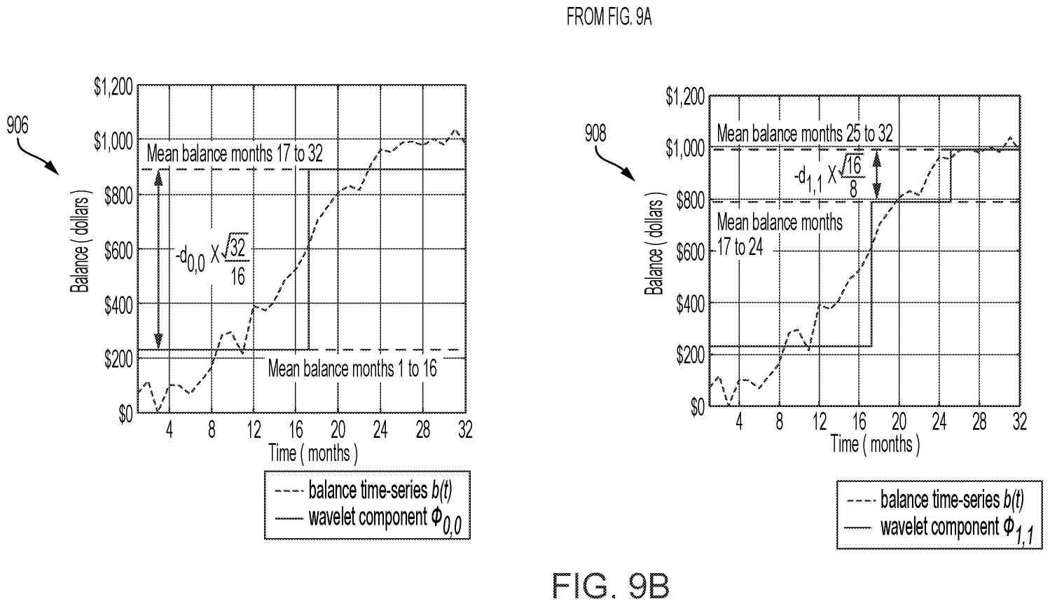

Matrix 704 shows results of applying basis functions of a wavelet transformation on the parameters. The wavelet transformation can be a Haar wavelet transformation. Summing each row of the matrix 704 results in a reconstruction of the original parameter pattern, meaning no information is lost. Parameter wavelet coefficients are generated by applying the basis functions on the parameters. The parameter wavelet coefficients are shown on the right of the matrix 704. A subset of parameter wavelet coefficients that are higher than remaining parameter wavelet coefficients may be selected. For example, the parameter wavelet coefficients underlined in FIG. 7 correspond to the top eight contributing basis functions of the wavelet transform as ranked by magnitude. The subset of parameter wavelet coefficients can correspond to a subset of basis functions of the wavelet transform that can be focused on individually or in various combinations to allow for interpreting what the pattern of parameters might mean, as further described in FIGS. 8-9.

FIGS. 8A-8B show charts depicting examples of basis functions of a wavelet transformation and approximating time-series data with basis functions, according to certain aspects of the present disclosure. FIG. 8A illustrates a set of basis functions for the Haar wavelet transformation. Time-series data can be decomposed into a weighted set of basis functions from which the time-series data can be recovered. FIG. 8B shows time-series data representing an account balance over time for a given consumer. Haar wavelet approximation appears as a stair-step curve overlaid on the account balance. Additional basis functions for the Haar wavelet transformation can be added to the set of basis functions at more refined time scales to reconstruct the time-series data.

The basis functions of a wavelet transformation shown in FIG. 8A are for illustration only and should not be construed as limiting. Other types of basis functions can also be used. For example, the basis functions can be a transformed version of the basis functions in FIG. 8A. The transformation can include flipping the basis functions such that the basis functions are reversed in time, as shown in FIG. 8C. Other transformations are also possible.

FIG. 9 shows graphs depicting examples of wavelet coefficients and corresponding basis functions shown in FIG. 8A that are applied to time-series data according to certain aspects of the present disclosure. Graph 902 shows the wavelet coefficients generated by applying a subset of basis functions of a wavelet transformation on time-series data for an attribute. The subset of basis functions is selected based on applying basis functions of the wavelet transformation on the parameters of the feature learning model and selecting basis functions that are associated with a higher parameter wavelet coefficient than other basis functions, as described in FIG. 7. Eight wavelet coefficients are shown as being generated by applying the subset of basis functions on the time-series data.

The basis functions corresponding to the first three wavelet coefficients, which correspond to c₀, d_{0,0}, and d_{1,1}, are then applied to the time-series data to generate explanatory data. The first wavelet coefficient, shown in graph 904, corresponds to the mean balance for the last thirty-two months. The second wavelet coefficient, shown in graph 906, is directly proportional to the difference between the average balances of the last sixteen months and the sixteen months prior to that, and thus gives an indication of how much the balance is changing over the thirty-two-month period. The third wavelet coefficient, shown in graph 908, is directly proportional to the difference between average balances of the last eight months and the eight months prior to that in the last sixteen-month period. As a result, features or characteristics such as the overall balance level, how much the balance has changed over different time-scales, and where the changes have occurred in time can be determined. Based on the determination, explanatory data can be generated for the time-series data to include these features or characteristics as the most significant contributing factors of the risk prediction.

### Example of Computing System for Machine-Learning Operations

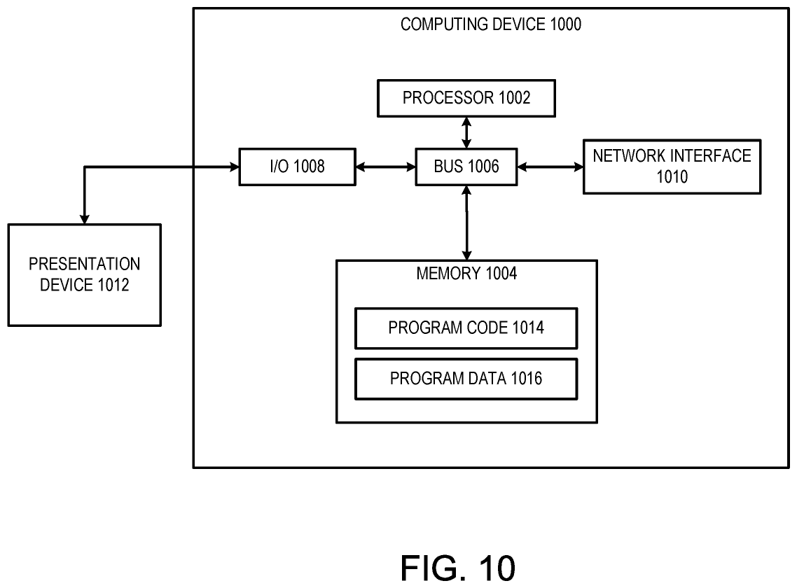

Any suitable computing system or group of computing systems can be used to perform the operations for the machine-learning operations described herein. For example, FIG. 10 is a block diagram depicting an example of a computing device 1000, which can be used to implement the risk assessment server 118 or the network training server 110. The computing device 1000 can include various devices for communicating with other devices in the operating environment 100, as described with respect to FIG. 1. The computing device 1000 can include various devices for performing one or more operations described above with respect to FIGS. 1-9.

The computing device 1000 can include a processor 1002 that is communicatively coupled to a memory 1004. The processor 1002 executes computer-executable program code stored in the memory 1004, accesses information stored in the memory 1004, or both. Program code may include machine-executable instructions that may represent a procedure, a function, a subprogram, a program, a routine, a subroutine, a module, a software package, a class, or any combination of instructions, data structures, or program statements. A code segment may be coupled to another code segment or a hardware circuit by passing or receiving information, data, arguments, parameters, or memory contents. Information, arguments, parameters, data, etc. may be passed, forwarded, or transmitted via any suitable means including memory sharing, message passing, token passing, network transmission, among others.

Examples of a processor 1002 include a microprocessor, an application-specific integrated circuit, a field-programmable gate array, or any other suitable processing device. The processor 1002 can include any number of processing devices, including one. The processor 1002 can include or communicate with a memory 1004. The memory 1004 stores program code that, when executed by the processor 1002, causes the processor to perform the operations described in this disclosure.

The memory 1004 can include any suitable non-transitory computer-readable medium. The computer-readable medium can include any electronic, optical, magnetic, or other storage device capable of providing a processor with computer-readable program code or other program code. Non-limiting examples of a computer-readable medium include a magnetic disk, memory chip, optical storage, flash memory, storage class memory, ROM, RAM, an ASIC, magnetic storage, or any other medium from which a computer processor can read and execute program code. The program code may include processor-specific program code generated by a compiler or an interpreter from code written in any suitable computer-programming language. Examples of suitable programming language include Hadoop, C, C++, C#, Visual Basic, Java, Python, Perl, JavaScript, ActionScript, etc.

The computing device 1000 may also include a number of external or internal devices such as input or output devices. For example, the computing device 1000 is shown with an input/output interface 1008 that can receive input from input devices or provide output to output devices. A bus 1006 can also be included in the computing device 1000. The bus 1006 can communicatively couple one or more components of the computing device 1000.

The computing device 1000 can execute program code 1014 that includes the risk assessment application 114 and/or the network training application 112. The program code 1014 for the risk assessment application 114 and/or the network training application 112 may be resident in any suitable computer-readable medium and may be executed on any suitable processing device. For example, as depicted in FIG. 10, the program code 1014 for the risk assessment application 114 and/or the network training application 112 can reside in the memory 1004 at the computing device 1000 along with the program data 1016 associated with the program code 1014, such as the time-series data for attributes 124 and/or the training dataset 126. Executing the risk assessment application 114 or the network training application 112 can configure the processor 1002 to perform the operations described herein.

In some aspects, the computing device 1000 can include one or more output devices. One example of an output device is the network interface device 1010 depicted in FIG. 10. A network interface device 1010 can include any device or group of devices suitable for establishing a wired or wireless data connection to one or more data networks described herein. Non-limiting examples of the network interface device 1010 include an Ethernet network adapter, a modem, etc.

Another example of an output device is the presentation device 1012 depicted in FIG. 10. A presentation device 1012 can include any device or group of devices suitable for providing visual, auditory, or other suitable sensory output. Non-limiting examples of the presentation device 1012 include a touchscreen, a monitor, a speaker, a separate mobile computing device, etc. In some aspects, the presentation device 1012 can include a remote client-computing device that communicates with the computing device 1000 using one or more data networks described herein. In other aspects, the presentation device 1012 can be omitted.

The foregoing description of some examples has been presented only for the purpose of illustration and description and is not intended to be exhaustive or to limit the disclosure to the precise forms disclosed. Numerous modifications and adaptations thereof will be apparent to those skilled in the art without departing from the spirit and scope of the disclosure.

What is claimed is:

1. A method that includes one or more processing devices performing operations comprising:
applying a risk prediction model to time-series data for an attribute associated with a target entity to generate a risk indicator for the target entity, wherein the risk prediction model comprises a feature learning model configured to receive the time-series data as input and a risk classification model configured to receive output of the feature learning model and generate the risk indicator as output;
accessing parameters of the feature learning model;
applying a plurality of basis functions of a wavelet transformation on the parameters of the feature learning model to generate a set of parameter wavelet coefficients;
generating explanatory data for the risk indicator based on the set of parameter wavelet coefficients; and
transmitting, to a remote computing device, a responsive message including at least the risk indicator and the explanatory data for use in controlling access of the target entity to one or more interactive computing environments.

2. The method of claim 1, wherein the operations further comprise selecting a subset of parameter wavelet coefficients from the set of parameter wavelet coefficients that have parameter wavelet coefficients higher than remaining parameter wavelet coefficients in the set.

3. The method of claim 2, wherein each parameter wavelet coefficient in the subset of parameter wavelet coefficients corresponds to a basis function in the plurality of basis functions.

4. The method of claim 1, wherein the feature learning model is a convolutional neural network configured to accept the time-series data as input and output a feature vector.

5. The method of claim 1, wherein the risk prediction model is trained via a training process comprising:
adjusting parameters of the risk prediction model to minimize a loss function defined based on risk indicators generated for training time-series data and training risk indicators corresponding to the training time-series data.

6. The method of claim 1, wherein the operations further comprise:
receiving a risk assessment query for the target entity prior to applying the risk prediction model to the time-series data for the attribute associated with the target entity; and
accessing the attribute associated with the target entity from a database configured to store a plurality of attributes associated with a plurality of entities.

7. The method of claim 1, wherein the explanatory data indicates a feature of the time-series data that has a higher contribution to the risk indicator than other features of the time-series data.

8. The method of claim 1, wherein the operations further comprise:
providing a recommendation to the target entity based on the explanatory data, wherein the recommendation indicates one or more actions for the target entity to take to improve the risk indicator.

9. A system comprising:
a processor; and
a non-transitory computer-readable medium comprising instructions that are executable by the processor to cause the processor to perform operations comprising:
applying a risk prediction model to time-series data for an attribute associated with a target entity to generate a risk indicator for the target entity, wherein the risk prediction model comprises a feature learning model configured to receive the time-series data as input and a risk classification model configured to receive output of the feature learning model and generate the risk indicator as output;
accessing parameters of the feature learning model;
applying a plurality of basis functions of a wavelet transformation on the parameters of the feature learning model to generate a set of parameter wavelet coefficients;
generating explanatory data for the risk indicator based on the set of parameter wavelet coefficients; and
transmitting, to a remote computing device, a responsive message including at least the risk indicator and the explanatory data for use in controlling access of the target entity to one or more interactive computing environments.

10. The system of claim 9, wherein the operations further comprise selecting a subset of parameter wavelet coefficients from the set of parameter wavelet coefficients that have parameter wavelet coefficients higher than remaining parameter wavelet coefficients in the set.

11. The system of claim 10, wherein each parameter wavelet coefficient in the subset of parameter wavelet coefficients corresponds to a basis function in the plurality of basis functions.

12. The system of claim 9, wherein the feature learning model is a convolutional neural network configured to accept the time-series data as input and output a feature vector.

13. The system of claim 9, wherein the risk prediction model is trained via a training process comprising:
adjusting parameters of the risk prediction model to minimize a loss function defined based on risk indicators generated for training time-series data and training risk indicators corresponding to the training time-series data.

14. The system of claim 9, wherein the operations further comprise:
receiving a risk assessment query for the target entity prior to applying the risk prediction model to the time-series data for the attribute associated with the target entity; and
accessing the attribute associated with the target entity from a database configured to store a plurality of attributes associated with a plurality of entities.

15. The system of claim 9, wherein the explanatory data indicates a feature of the time-series data that has a higher contribution to the risk indicator than other features of the time-series data.

16. The system of claim 9, wherein the operations further comprise:
providing a recommendation to the target entity based on the explanatory data, wherein the recommendation indicates one or more actions for the target entity to take to improve the risk indicator.

17. A non-transitory computer-readable medium comprising instructions that are executable by a processing device for causing the processing device to perform operations comprising:
applying a risk prediction model to time-series data for an attribute associated with a target entity to generate a risk indicator for the target entity, wherein the risk prediction model comprises a feature learning model configured to receive the time-series data as input and a risk classification model configured to receive output of the feature learning model and generate the risk indicator as output;
accessing parameters of the feature learning model;
applying a plurality of basis functions of a wavelet transformation on the parameters of the feature learning model to generate a set of parameter wavelet coefficients;
generating explanatory data for the risk indicator based on the set of parameter wavelet coefficients; and
transmitting, to a remote computing device, a responsive message including at least the risk indicator and the explanatory data for use in controlling access of the target entity to one or more interactive computing environments.

18. The non-transitory computer-readable medium of claim 17, wherein the operations further comprise selecting a subset of parameter wavelet coefficients from the set of parameter wavelet coefficients that have parameter wavelet coefficients higher than remaining parameter wavelet coefficients in the set.

19. The non-transitory computer-readable medium of claim 18, wherein each parameter wavelet coefficient in the subset of parameter wavelet coefficients corresponds to a basis function in the plurality of basis functions.

20. The non-transitory computer-readable medium of claim 17, wherein the operations further comprise:
providing a recommendation to the target entity based on the explanatory data, wherein the recommendation indicates one or more actions for the target entity to take to improve the risk indicator.
